(19) United States
(12) Patent Application Publication
(10) Pub. No.: US 2017/0297712 A1
(43) Pub. Date: Oct. 19, 2017

(54) SMALL UAVS WITH RADAR RECEIVERS TO BE USED AS BISTATIC RADAR LAUNCHED FROM TACTICAL FIGHTER JETS

(71) Applicant: The Boeing Company, Chicago, IL (US)

(72) Inventors: Inyoung Daniel Kim, St. Louis, MO (US); Thomas M. Rose, St. Louis, MO (US); Dale Waldo, St. Louis, MO (US)

(21) Appl. No.: 14/524,268

(22) Filed: Oct. 27, 2014

(51) Int. Cl. B64D 5/00; B64C 39/02; G01S 13/00; F42B 15/08; G01S 7/00

(52) U.S. Cl. CPC B64D 5/00; F42B 15/08; G01S 7/003; G01S 13/003; B64C 39/024; B64C 2201/082; B64C 2201/102; B64C 2201/122; B64C 2201/146

(57) ABSTRACT

A system for bistatic radar target detection employs an unmanned aerial vehicle (UAV) having a radar antenna for bistatic reception of reflected radar pulses. The UAV operates with a flight profile in contested airspace. A tactical fighter aircraft having a radar transmitter for transmitting radar pulses operates with a flight profile in uncontested airspace. A communications data link operably interconnects the UAV and the tactical fighter aircraft, the communications data link transmitting data produced by the bistatic reception of reflected radar pulses in the UAV radar antenna to the fighter aircraft.

### BACKGROUND INFORMATION

### Field

Embodiments of the disclosure relate generally to tactical radar systems and more particularly to a system employing small unmanned air vehicles (UAV) deployed into contested airspace acting as bistatic radar receivers for tactical fighter jets providing the transmitting radar with data transmission from the UAV to the fighter jet for target information while allowing the fighter jet to remain out of potentially hostile airspace.

### Background

Aircraft reconnaissance and interdiction has been significantly complicated by the appearance highly accurate and often minimally detectable antiaircraft weapons. Consequently, most current tactical combat aircraft entering into contested or hostile airspace are placed at risk. The range of these weapons may be significant thus requiring a significant standoff distance to avoid the contested airspace, often beyond the effective range of radar systems employed in current tactical aircraft. The use of stealth aircraft to penetrate hostile airspace and accomplish such missions provides a certain level of increased survivability but such aircraft are highly expensive assets and are used only upon critical need.

It is therefore desirable to provide a system whereby current inventory tactical aircraft may remain clear of contested airspace while being able to use radar surveillance for target identification.

### SUMMARY

Exemplary embodiments provide a system for bistatic radar target detection employing an unmanned aerial vehicle (UAV) having a radar antenna for bistatic reception of reflected radar pulses. The UAV operates with a flight profile in contested airspace. A tactical fighter aircraft having a radar transmitter for transmitting radar pulses operates with a flight profile in uncontested airspace. A communications data link operably interconnects the UAV and the tactical fighter aircraft, the communications data link transmitting data produced by the bistatic reception of reflected radar pulses in the UAV radar antenna to the fighter aircraft.

The embodiments disclosed provide a method for bistatic radar target detection by launching a UAV and navigating the UAV into contested airspace while maintaining a fighter aircraft on a flight profile in uncontested airspace. A high power radar system on the fighter aircraft is employed to emit radar pulses and a radar antenna on the UAV is employed as a bistatic receiver to receive reflected radar pulses from targets. Target data is then transmitted from the UAV via a communications data link to the fighter aircraft.

### BRIEF DESCRIPTION OF THE DRAWINGS

The features, functions, and advantages that have been discussed can be achieved independently in various embodiments of the present disclosure or may be combined in yet other embodiments, further details of which can be seen with reference to the following description and drawings.

FIG. 1A is a pictorial representation of a current tactical combat aircraft with which the disclosed embodiments may be employed;

FIG. 1B is a detailed representation of external payload mounting of unmanned aerial vehicles (UAV) employed in the embodiments disclosed;

FIG. 2 is a representation of the tactical aircraft and UAV after launch;

FIG. 3 is a representation of the bistatic radar employed by the embodiment;

FIG. 4 is a block diagram of the system elements in the UAV and aircraft; and,

FIG. 5 is a flow chart of a method for implementing the disclosed embodiments.

### DETAILED DESCRIPTION

The system and methods described herein provide embodiments using small UAVs which are rack mountable/launchable from the air to be used as bistatic radar. The UAV is modified to carry a datalink and an appropriate radar receiver. The UAVs are launched and controlled from fighter jet such as a two-seat F-15 Eagle or F-18 Hornet. The bistatic radar combination of the UAV and fighter aircraft dramatically increases the detection range of the radar on board fighter aircraft.

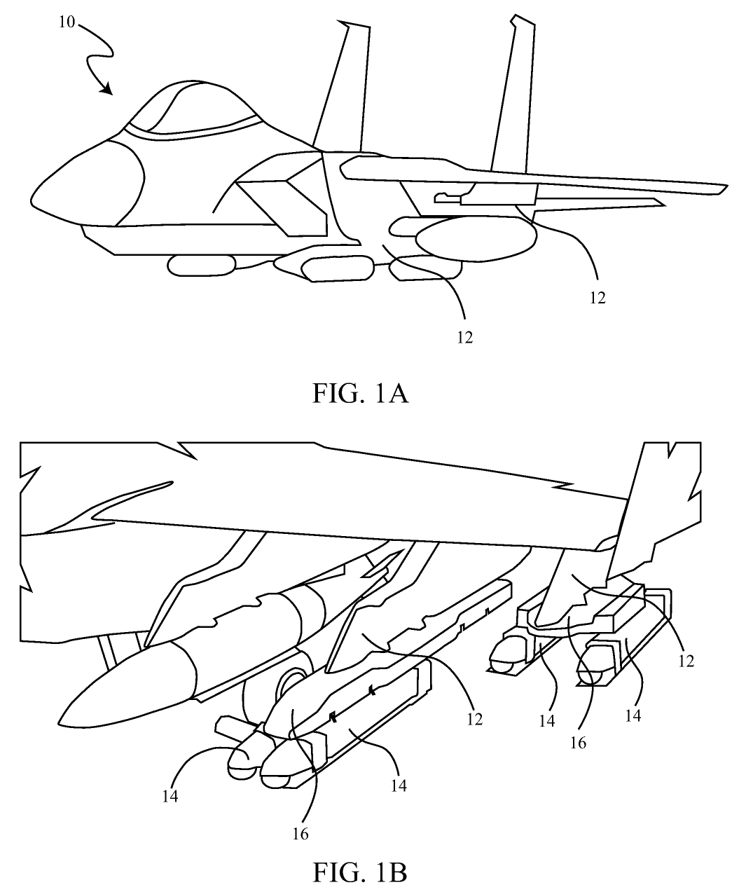

Referring to the drawings, FIG. 1A shows a tactical fighter aircraft 10 which may be employed with the system embodiments described herein. The aircraft depicted is an F-15 Eagle having multiple underwing or under fuselage pylons 12 which may support munitions or other external loads. While the aircraft 10 in the exemplary embodiment is disclosed with external load carrying capability, aircraft with internal or conformal weapons bays may also be employed. FIG. 1B shows a detailed view of exemplary mounting of multiple UAVs 14 on several pylons 12 to allow launch and monitoring of UAVs into multiple reconnaissance locations sequentially or simultaneously. The UAV will be launched with a launch rack 16 which adapts to the host aircraft's existing pylon. The rack 16 will may employ an Ethernet or fiber optic port, as will be described in greater detail subsequently, to load mission data from the aircraft's mission computer prior to launch. The UAV's wing is stored internal to the UAV and deployed shortly after launch of the UAV from the rack 16. The UAV will free fall to clear out of the host fighter aircraft prior to deploying the wing or other control surfaces which may interfere with the rack 18, pylon 12 or aircraft. Once the wing and/or control surfaces are deployed and the UAV is clear from the aircraft, then the engine of the UAV will be initiated.

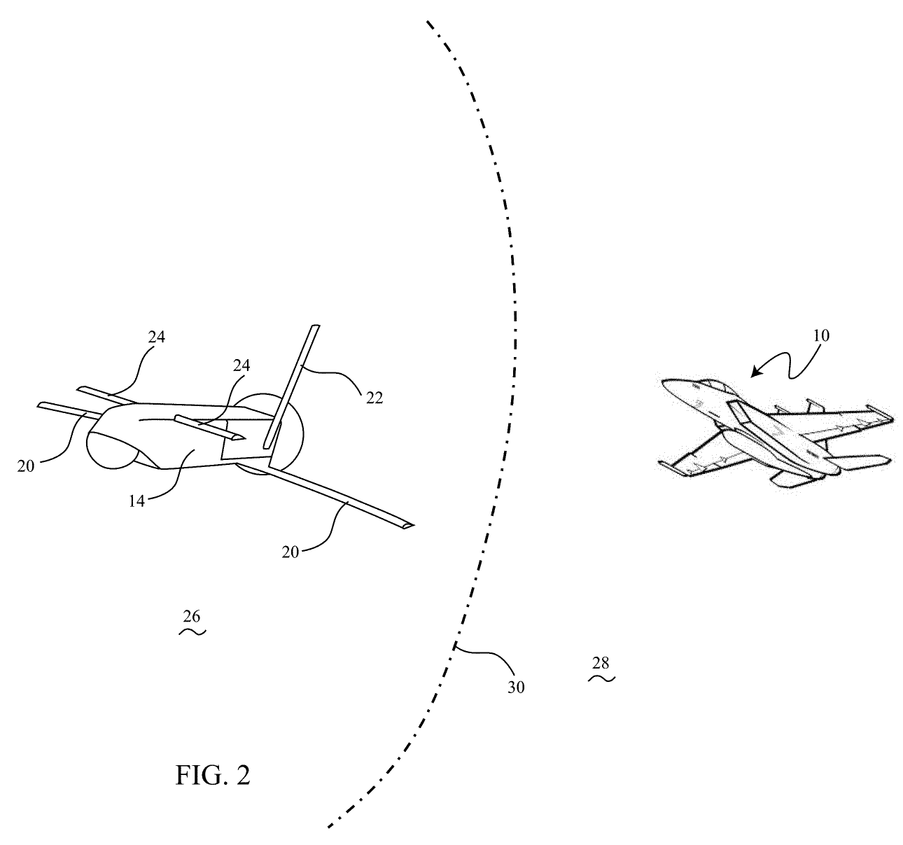

As represented in FIG. 2, after launch the UAV 14, with wings 20, vertical control surface 22 and horizontal control surfaces 24 deployed, is navigated, either autonomously with downloaded mission profile information or directly by aircrew in the fighter aircraft 10, into the contested airspace 26, represented as separated from uncontested or safe airspace 28 by boundary 30. While UAV 14 is depicted in the exemplary embodiment as a propeller driven vehicle, turbojet or rocket powered vehicles may also be employed.

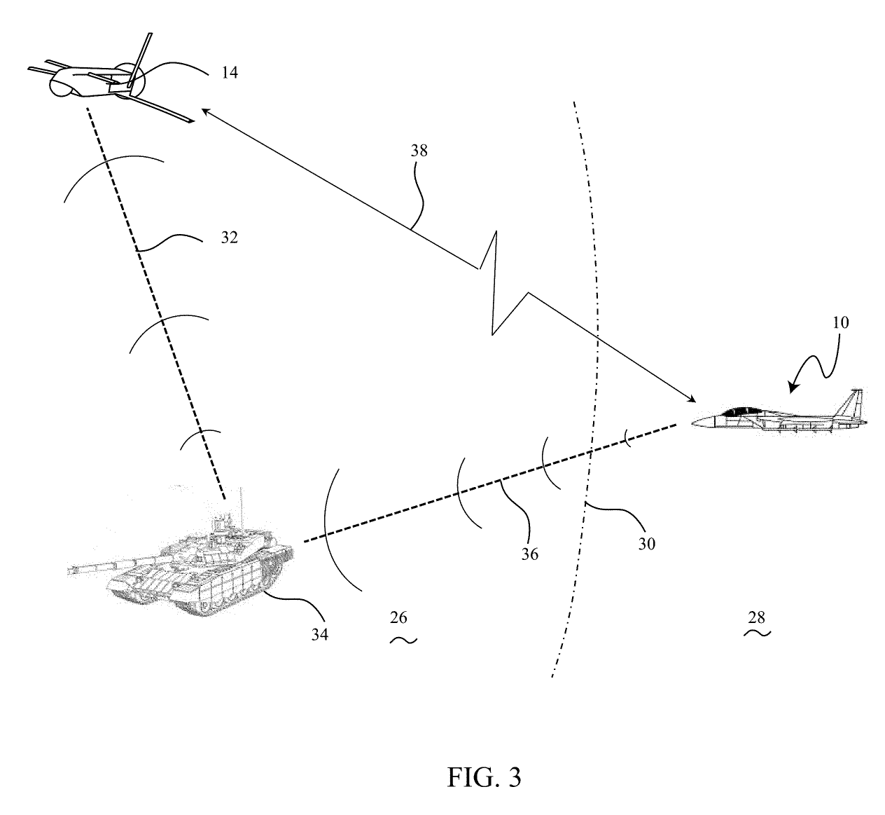

In the contested airspace 26 UAV 14 provides a passive bistatic receiver for reflected radar pulses 32 from targets such as tank 34 by impinging radar pulses 36 emitted by the radar of the fighter aircraft 10, which may remain in the uncontested airspace 28 as shown in FIG. 3. In the exemplary embodiments, the UAV 14 will be carrying receive only radar antenna and the host tactical fighter aircraft 10 will be carrying the transmit/receive radar. The fighter aircraft 10 has the capability to carry a radar system with power output of orders of magnitude of 10 or higher than that of the UAV 14 and thus is it possible for the fighter aircraft to stay in standoff range and radiate while remaining clear out of harm's way while UAV may need to stay “radio silence” to maintain its low observable nature. Passive operation enhances the ability of the location of the UAV 14 to be masked from hostile radar detection systems. Data characterizing target(s) such as tank 34 from the bistatically received radar data is then transmitted by the UAV 14 to the fighter aircraft 10 by datalink transmission 38.

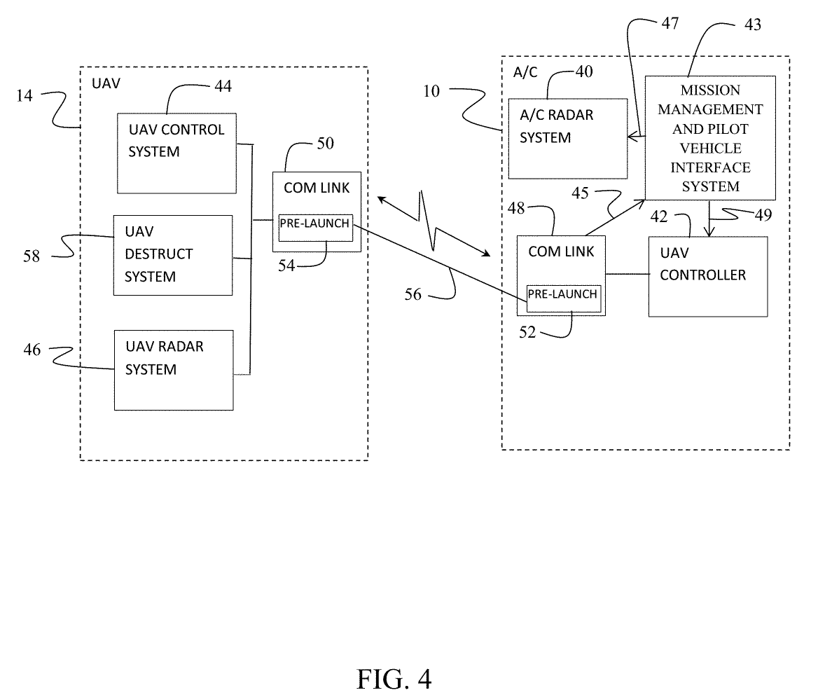

The system components incorporated in the UAV 14 and fighter aircraft 10 are shown in FIG. 4. The fighter aircraft 10 incorporates a high power transmit and receive radar system 40 and a UAV controller 42. A mission management system/pilot vehicle interface system 43 integral to the fighter aircraft and adapted for interface to a crewmember on the fighter aircraft provides interface control for the radar system 40 and the UAV controller 42. The UAV controller may be operated by a crewmember on the fighter aircraft 10 for direct control of the UAV flight profile and UAV radar system. The UAV 14 incorporates a UAV flight control system 44 which controls the flight profile of the UAV. UAV radar system 46 is typically a passive radar antenna and data processing system for receiving and processing bistatic radar signals. However, in certain embodiments, the radar system may include transmitting capability to supplement the radar transmission from the fighter aircraft 10. A communications data link 48 in the fighter aircraft 10 and a mating communications data link 50 in the UAV 14 are operably connected to provide communications between the fighter aircraft and the UAV. Data from the communications data link 48 to the mission management and pilot vehicle interface system 43 represented by arrow 45 provides bistatic radar information from the UAV radar system 46 and data regarding the UAV position and flight profile from the UAV control system 44 to the mission management and pilot vehicle interface system 43 for display. Radar commands 47 from the mission management and pilot vehicle interface system 43 to the aircraft radar system 40 provide commands to the radar to directionally control the radar beam to the intended target. UAV commands 49 from the mission management and pilot vehicle interface system 43 to the UAV controller 42 provide input through the communications data link 48 to command the UAV to fly/orbit/loiter in a desired flight profile. In the exemplary embodiment, an L-band (1.5 to 4 GHz) data link for line of sight bidirectional communication is employed. The UAV may remain primarily in a receive only mode. The data link will contain messages which will be used to direct and control the UAV's flight control system 44 as well as the radar system 46, as needed. The UAV will use the data link to report its location and current air vehicle status back to the host fighter aircraft as well as transmission of data from the radar system 46. The communications data links 48, 50 may employ data burst or beam agility capability for covert operation. As previously described, the communications data links 48, 50 may also employ pre-launch communications elements 52, 54 “hardwire” connected through Ethernet or fiber optic port 56 as previously described for pre-launch communication between the fighter aircraft 10 and UAV 14.

Accordingly, the UAV is not tethered, but rather the UAV is releasably coupled to a host aircraft's existing pylon (or other mounting structure) in a manner such that the UAV may be deployed from and guided by the UAV controller in the fighter aircraft towards a target in a contested airspace, to thereby increase the target detection range beyond the fighter aircraft such that the fighter aircraft can stay out of contested airspace while collecting radar data on a target within the contested airspace.

The UAV 14 may be retrieved via conventional landing after a flight profile exiting the contested airspace or the UAV will carry a destruct system 58 with explosives for self-destruction purposes on vital communication and radar subsystems in the UAV. The destruct system 58 may be activated, either as a portion of the flight profile or upon loss of data link communications, through the UAV control system 44, or upon instruction from mission management and pilot vehicle interface system 43 through the UAV controller 42 on the fighter aircraft 10 transmitted using communications data links 48, 50.

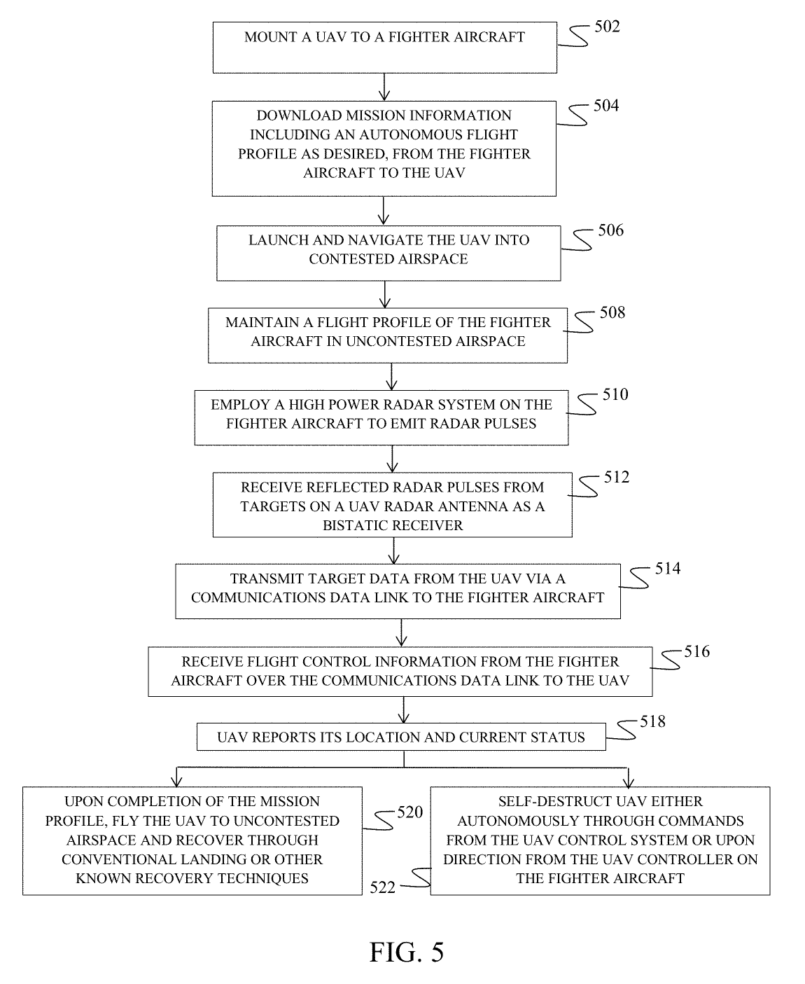

The embodiments disclosed herein allow a method of target detection as shown in FIG. 5. A UAV is mounted to a fighter aircraft, step 502, and mission information, potentially including an autonomous flight profile, may be downloaded from the fighter aircraft to the UAV, step 504. The UAV is launched and navigated into contested airspace, step 506, while the fighter aircraft maintains a flight profile in uncontested airspace, step 508. The fighter aircraft employs a high power radar system to emit radar pulses, step 510, and the UAV employs a radar antenna as a bistatic receiver to receive reflected radar pulses from targets, step 512. The UAV then transmits target data via a communications data link to the fighter aircraft, step 514. The UAV may additionally receive flight control information from the fighter aircraft over the communications data link, step 516, and may report its location and current status, step 518. Upon completion of the mission profile, the UAV may fly to uncontested airspace and be recovered through conventional landing or other known recovery techniques, step 520. Alternatively, the UAV may self-destruct either autonomously through commands from the UAV control system or upon direction from the UAV controller on the fighter aircraft, step 522. While described herein as launched from the fighter aircraft, the UAV may be conventionally launched from other ground or airborne assets for the desired flight profile into contested airspace achieving data link communication with the fighter aircraft when both have established their respective flight profiles.

Having now described various embodiments of the disclosure in detail as required by the patent statutes, those skilled in the art will recognize modifications and substitutions to the specific embodiments disclosed herein. Such modifications are within the scope and intent of the present disclosure as defined in the following claims.

1. A system for bistatic radar target detection comprising:
an unmanned aerial vehicle (UAV) having a radar antenna for bistatic reception of reflected radar pulses, said UAV operating with a UAV flight profile in contested airspace;
a tactical fighter aircraft having a radar transmitter for transmitting radar pulses, said tactical fighter aircraft operating with an aircraft flight profile in uncontested airspace; and,
a communications data link operably interconnecting the UAV and the tactical fighter aircraft , said communications data link transmitting data produced by the bistatic reception of reflected radar pulses in the UAV radar antenna to the fighter aircraft.

2. The system for bistatic radar target detection as defined in claim 1 further comprising a UAV controller in the fighter aircraft, said UAV controller operably connected to the communications data link and transmitting flight control information to a UAV flight control system to control the UAV flight profile.

3. The system for bistatic radar target detection as defined in claim 1 wherein the UAV is mountable to the fighter aircraft and deployed from the fighter aircraft for the UAV flight profile.

4. The system for bistatic radar target detection as defined in claim 3 wherein the UAV has wings stowable in a first position prior to being deployed and extendible to an operating position after being deployed.

5. The system for bistatic radar target detection as defined in claim 3 wherein the UAV has control surfaces stowable in a first position prior to being deployed and extendible to an operating position after being deployed.

6. The system for bistatic radar target detection as defined in claim 5 wherein the UAV is mountable to a standard pylon on the fighter aircraft.

7. The system for bistatic radar target detection as defined in claim 2 further comprising a self-destruct system in the UAV.

8. The system for bistatic radar target detection as defined in claim 7 wherein the self-destruct system is operable by the UAV flight control system or the UAV controller.

9. A system for bistatic radar target detection comprising:
an unmanned aerial vehicle (UAV) having a radar antenna for bistatic reception of reflected radar pulses, said UAV operating with a UAV flight profile in contested airspace;
a tactical fighter aircraft having a radar transmitter for transmitting radar pulses, said tactical fighter aircraft operating with an aircraft flight profile in uncontested airspace;
a communications data link operably interconnecting the UAV and the tactical fighter aircraft, said communications data link transmitting data produced by the bistatic reception of reflected radar pulses in the UAV radar antenna to the fighter aircraft; and,
a self-destruct system in the UAV wherein the self-destruct system is operable by the UAV controller and wherein the UAV is releasably coupled to a standard pylon on the fighter aircraft in a manner such that the UAV may be deployed from and guided by the UAV controller in the fighter aircraft towards a target in a contested airspace, to thereby increase the target detection range beyond the fighter aircraft, whereby the fighter aircraft can stay out of contested airspace while collecting radar data on a target within the contested airspace.

10. A method for bistatic radar target detection comprising:
launching a UAV and navigating the UAV into contested airspace;
maintaining a fighter aircraft on a flight profile in uncontested airspace;
employing a high power radar system on the fighter aircraft to emit radar pulses;
employing a radar antenna on the UAV as a bistatic receiver to receive reflected radar pulses from targets; and,
transmitting target data from the UAV via a communications data link to the fighter aircraft.

11. The method as defined in claim 10 further comprising:
mounting the UAV to a pylon on the fighter aircraft; and,
the step of launching the UAV comprises launching the UAV from the fighter aircraft.

12. The method as defined in claim 11 further comprising:
downloading mission information from the fighter aircraft to the UAV.

13. The method as defined in claim 12 wherein the mission information includes a flight profile for the UAV.

14. The method as defined in claim 11 further comprising: receiving flight control information to the UAV from the fighter aircraft over the communications data link.

15. The method as defined in claim 11 further comprising:
reporting location and current status by the UAV over the communications data link.

16. The method as defined in claim 10 further comprising:
flying the UAV to uncontested airspace upon completion of the mission profile; and,
recovering the UAV through conventional landing or other known recovery techniques.

17. The method as defined in claim 10 further comprising:
causing the UAV to self-destruct after completion of a mission profile.

18. The method as defined in claim 17 wherein the step of causing the UAV to self-destruct is autonomous through commands from the UAV control system.

19. The method as defined in claim 17 wherein the step of causing the UAV to self-destruct occurs upon direction from the UAV controller on the fighter aircraft.
